(19) United States
(12) Patent Application Publication
(10) Pub. No.: US 2014/0048564 A1
(43) Pub. Date: Feb. 20, 2014

(54) Liquid Discharging Container

(71) Applicant: Sang Jeong An, Suwon-si (KR)

(72) Inventor: Sang Jeong An, Suwon-si (KR)

(21) Appl. No.: 14/009,839

(22) PCT Filed: May 7, 2012
(86) PCT No.: PCT/KR2012/003561

§ 371 Date: Oct. 14, 2013

(30) Foreign Application Priority Data
May 5, 2011 (KR) 10-2011-0042736

(51) Int. Cl. B05B 11/00

(52) U.S. Cl. CPC B05B 11/3042
USPC 222/382

(57) ABSTRACT

The present invention relates to a liquid discharging container including: a body in which liquid is contained and having a first chamber, a second chamber formed under the first chamber, and a neck formed between the first chamber and the second chamber in such a manner as to resist the liquid movement between the first chamber and the second chamber; and a sprayer coupled to the body and having a hose extended downward to the first chamber below.

### FIELD

The present invention relates to a liquid discharging container, and more particularly, to a liquid discharging container that is capable of solving the problems caused when used in the state of being inclined.

### BACKGROUND

FIG. 1 is a perspective view showing one example of conventional liquid discharging containers, wherein the conventional liquid discharging container includes a body 100 in which liquid is contained and a sprayer 200 adapted to raise the liquid upward and thus to discharge the liquid to the outside.

### SUMMARY

Accordingly, the present invention has been made in view of the above-mentioned problems occurring in the prior art, and it is an object of the present invention to provide a liquid discharging container that is capable of solving the problems caused when used in the state of being inclined.

To accomplish the above object, according to the present invention, there is provided a liquid discharging container including: a body in which liquid is contained and having a first chamber, a second chamber formed under the first chamber, and a neck formed between the first chamber and the second chamber in such a manner as to resist the movement of liquid between the first chamber and the second chamber; and a sprayer coupled to the body and having a hose extended downward to the first chamber below.

According to the present invention, the liquid discharging container can solve the problems caused when used in the state of being inclined.

### BRIEF DESCRIPTION OF DRAWINGS

FIG. 1 is a perspective view showing one example of conventional liquid discharging containers.

FIG. 2 is a perspective view showing a liquid discharging container according to the present invention.

FIGS. 3 to 5 are perspective views showing the processes for containing liquid into the liquid discharging container according to the present invention.

### DETAILED DESCRIPTION

Hereinafter, an explanation on a liquid discharging container according to the present invention will be given in detail with reference to the attached drawings.

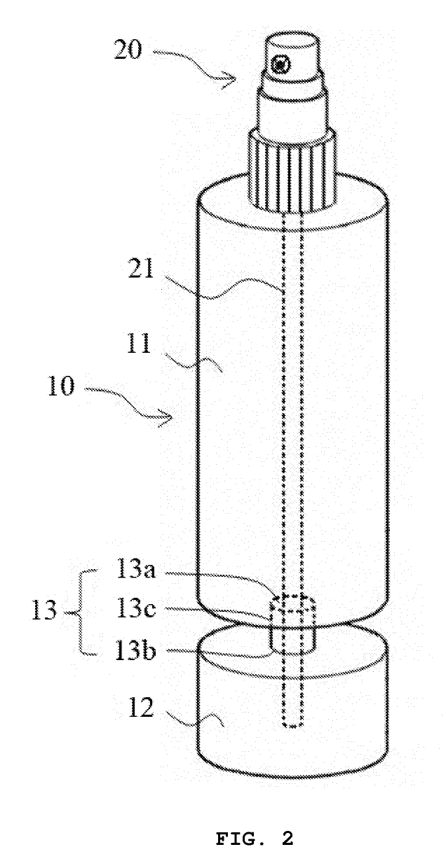

FIG. 2 is a perspective view showing a liquid discharging container according to the present invention. According to the present invention, the liquid discharging container largely includes a body 10 in which liquid is contained and a sprayer 20 adapted to discharge the liquid to the outside. The sprayer 20 generally discharges the liquid through the automization, but it may discharge the liquid in the form of stream. The body 10 has a first chamber 11, a second chamber 12 formed under the first chamber, and a neck 13 formed between the first chamber 11 and the second chamber 12 in such a manner as to resist the movement of liquid between the first chamber 11 and the second chamber 12. The neck 13 is defined by a first chamber side opening 13a narrowly formed on the lower side of the first chamber 11 and by a second chamber side opening 13b narrowly formed on the upper side of the second chamber 12 and is formed of a tube 13c connecting the first chamber side opening 13a and the second chamber side opening 13b to each other. The sprayer 20 is coupled to the body 10 and has a hose 21 extended downward to the first chamber 11 below. The hose 21 is desirably extended to the second chamber 12. Desirably, the tube 13c is reinforced by a rib 13d, thereby strengthening the neck 13. The rib 13d is extended outwardly from the tube 13b, and desirably, does not protrude outwardly from the first chamber 11 and the second chamber 12, which allows packaging in next process to be easily performed.

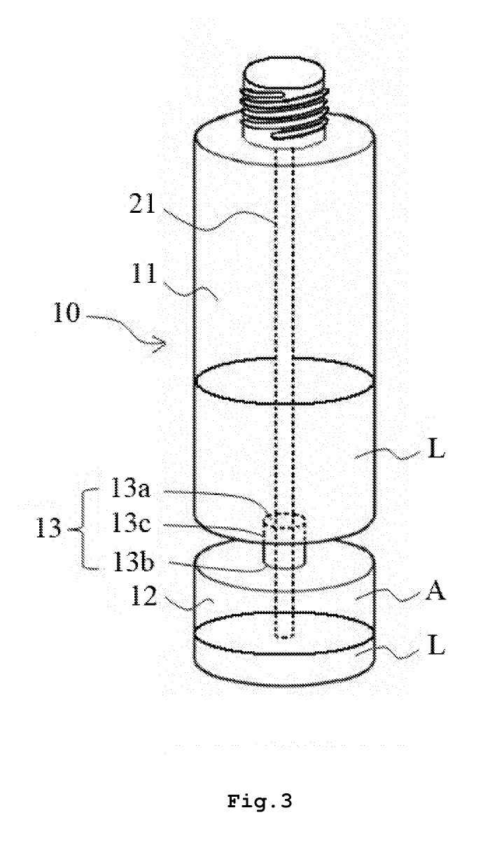

FIGS. 3 to 5 are perspective views showing the processes for containing liquid into the liquid discharging container according to the present invention.

As shown in FIG. 3, if liquid L is supplied, the neck 13 serves as the passage resisting the movement of the liquid L, unlike the conventional containers, so that the liquid L is not continuously supplied from the first chamber 11 to the second chamber 12 (in this case, the air staying in the second chamber 12 before the supply of the liquid L is not yet exhausted) and thus, a layer of air A is formed between the first chamber 11 and the second chamber 12.

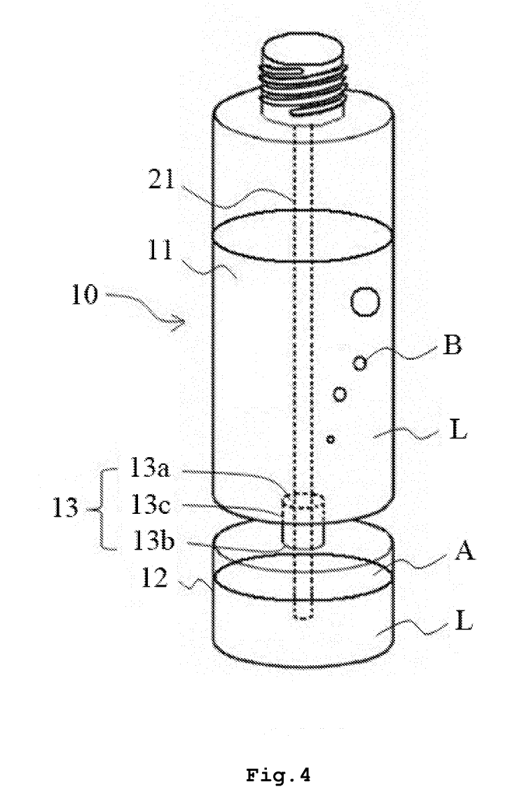

After that, as shown in FIG. 4, the liquid L is supplied from the first chamber 11 to the second chamber 12 by means of gravity, and the air in the second chamber 12 is exhausted in the form of air bubbles B since the upper portion of the second chamber 12 is closed.

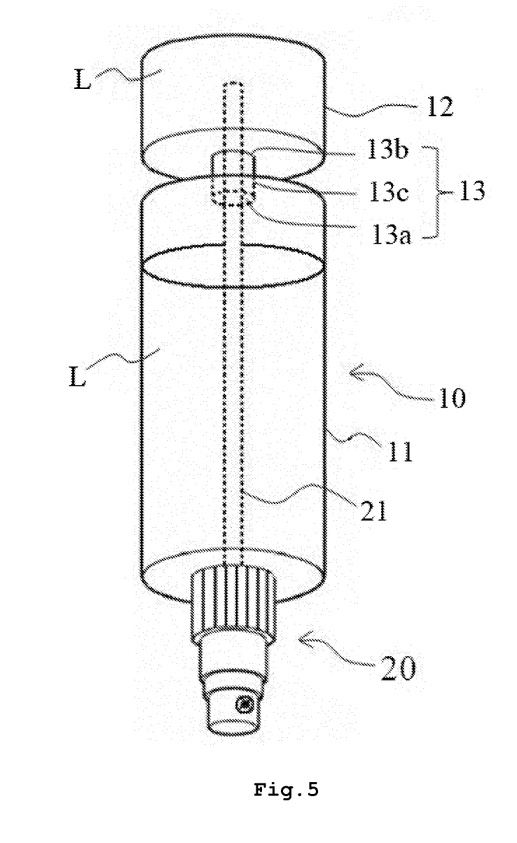

Next, as shown in FIG. 5, if the liquid discharging container is used after the completion of the supply of the liquid L, the liquid L in the second chamber 12 is not sent gently to the first chamber 11 by means of the neck 13 (that is, the neck 13 serves as the passage moving the air bubbles B in the opposite direction to the moving direction of the liquid L), and thus, if the liquid discharging container is used in the state of being turned over or inclined for a short period of time, the liquid L in the second chamber 12 mostly stays in the second chamber 12. The upper portion of the body 10 is open when the liquid L is supplied to the body 10, but it is closed when the liquid L is injected, so that such functions by the neck 13 are more effectively provided. Accordingly, even if the liquid discharging container is used in the state of being inclined, the liquid L is supplied to the hose 21, without any trouble. For example, the liquid discharging container is manufactured with the first chamber 11 having a diameter of 4.5 cm and a height of 12 cm, the second chamber 12 having a diameter of 4.5 cm and a height of 3 cm, and the neck 13 having a diameter of 1 cm and a height of 1.5 cm.

So as to allow the neck 13 to have enough resistance, desirably, the tube 13b should have a given length (for example, 1.5 cm). Alternatively, the neck 13 may be formed of an opening reduced in diameter, and at this time, the first chamber side opening 13a and the second chamber side opening 13b are formed unitarily to each other.

The liquid discharging container according to the present invention may be used in the following ways.

First, the liquid discharging container has the volume of the first chamber larger than that of the second chamber. That is, in using the liquid discharging container, the first chamber functions to fill the liquid to the second chamber, and accordingly, while the liquid discharging container is being used, the volume of the first chamber should be larger than that of the second chamber so as to solve the problems occurring in the conventional practice.

Second, the liquid discharging container has the height of the first chamber higher than that of the second chamber. That is, the first chamber serves to a grip of the liquid discharging container, and accordingly, the first chamber should have an appropriate height.

Third, the volume of the first chamber is two times larger than that of the second chamber. That is, when considering the above, it is desirable that the volume of the first chamber is two times larger than that of the second chamber.

Fourth, in case of the liquid discharging container being used for injecting edible oil, the edible oil is sprayed onto a fry fan, and therefore, the liquid discharging container is used inclinedly over 90°. In this case, the liquid discharging container according to the present invention can be appropriately used.

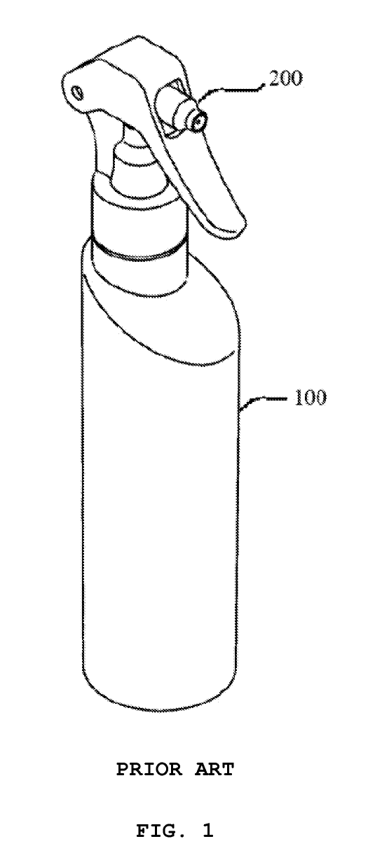

Last, in addition to the shapes as shown in FIGS. 1 and 2, the sprayer may have various shapes.

While the present invention will be described with reference to the particular illustrative embodiments, it is not to be restricted by the embodiment but only by the appended claims. It is to be appreciated that those skilled in the art can change or modify the embodiments without departing from the scope and spirit of the present invention.

What is claimed is:

1. A liquid discharging container comprising:
a body in which liquid is contained and having a first chamber, a second chamber formed under the first chamber, and a neck formed between the first chamber and the second chamber in such a manner as to resist the liquid movement between the first chamber and the second chamber; and
a sprayer coupled to the body and having a hose extended downward to the first chamber below.

2. The liquid discharging container according to claim 1, wherein the volume of the first chamber is larger than that of the second chamber.

3. The liquid discharging container according to claim 2, wherein the height of the first chamber is higher than that of the second chamber.

4. The liquid discharging container according to claim 3, wherein the volume of the first chamber is two times larger than that of the second chamber.

5. The liquid discharging container according to claim 1, wherein the neck is defined by a first chamber side opening narrowly formed on the lower side of the first chamber and by a second chamber side opening narrowly formed on the upper side of the second chamber.

6. The liquid discharging container according to claim 5, wherein the neck is formed of a tube connecting the first chamber side opening and the second chamber side opening to each other.

7. The liquid discharging container according to claim 1, wherein the neck serves as the passage resisting the movement of liquid by the formation of a layer of air between the first chamber and the second chamber when the liquid is supplied from the first chamber to the second chamber.

8. The liquid discharging container according to claim 1, wherein the neck serves as the passage moving air bubbles in the opposite direction to the moving direction of the liquid.

9. The liquid discharging container according to claim 8, wherein the volume of the first chamber is larger than that of the second chamber and the height of the first chamber is higher than that of the second chamber.

10. The liquid discharging container according to claim 9, wherein the neck is formed of the tube having a given length, the tube being reinforced by a rib, and the hose of the sprayer is passed through the tube and extended to the second chamber.
